(19) United States
(12) Patent Application Publication
(10) Pub. No.: US 2014/0164968 A1
(43) Pub. Date: Jun. 12, 2014

(54) Medical Photography User Interface Utilizing a Body Map Overlay in Camera Preview to Control Photo Taking and Automatically Tag Photo with Body Location

(71) Applicant: WinguMD, Inc., Palo Alto, CA (US)

(72) Inventor: Oliver AALAMI, Palo Alto, CA (US)

(73) Assignee: WinguMD, Inc., Palo Alto, CA (US)

(21) Appl. No.: 14/100,213

(22) Filed: Dec. 9, 2013

Related U.S. Application Data
(60) Provisional application No. 61/735,012, filed on Dec. 9, 2012.

(51) Int. Cl. G06F 3/0482; G06F 3/0488; G06F 3/0484

(52) U.S. Cl. CPC G06F 3/0482; G06F 3/04842; G06F 3/0488
USPC 715/771

(57) ABSTRACT

An image of a subject or a patient is displayed on a computing device. A body map overlay is displayed over the image. The body map comprises a plurality of body regions. Tapping a selected body region captures the image displayed and automatically tags the captured image with information regarding the body region that was captured. The image can subsequently be sent to a central database where a plurality of such images can be stored and later retrieved. The images can be indexed by body region or other parameters such as time, date, location, etc. The mobile application can also be used to access the database and show the images which may be ordered by body region or the other parameters.

### CROSS-REFERENCE

This application claims the benefit of U.S. Provisional Application No. 61/735,012, filed Dec. 9, 2012, which application is incorporated herein by reference.

### BACKGROUND OF THE INVENTION

Currently medical documentation is a largely systematic verbal description of presenting symptoms, medical history, physical exam results, and studies followed by assessments and plans. Descriptions from one provider to the next may not translate well and are often misunderstood. The use of photography may greatly reduce the amount of confusion between care providers that arise from differing descriptions of the same physical findings and symptoms. The widespread adoption of digital imaging on mobile devices makes it possible to dramatically increase the use of photography in medical documentation and communication between teams of care providers. The 2009 HITECH Act has provided incentives to physicians and hospitals to adopt health information technology; this points to the inevitability of the widespread adoption of electronic medical records. Consequently, there exist a need to develop information systems and technologies geared at fielding and implementing the widespread use of photography in medical communication and documentation.

The following references may be of interest: U.S. Pat. No. 8,452,063 to Wojton et al. and U.S. Pat. No. 7,461,079 to Walker et al. and U.S. Publication Nos. 2003/0055686 to Satoh et al., 2004/0078215 to Dahlin et al., 2009/0192823 to Hawkins et al., 2011/0231205 to Letts, 2011/0282686 to Venon et al., 2013/0177222 to Tridandapan et al., and 2013/0298082 to Soffer et al.

### SUMMARY OF THE INVENTION

Systems and method are provided for displaying, capturing, and tagging images, particularly for medical and clinical purposes. Generally, a computer application such as a mobile application of a smartphone or a tablet computer, for example, displays an image of a subject or a patient and further displays an overlay over the displayed image. The overlay may comprise a body map comprising a plurality of body regions. By tapping a selected body region, the mobile application captures the image displayed and automatically and often simultaneously tags the captured image with information regarding the body region that was captured. For example, if a user focuses his device on an arm of a subject, the arm of the subject is displayed, the user can tap an arm on the body map, and the image of the subject is automatically captured and tagged that the image is one of an arm. The image can subsequently be stored on the mobile device and may also be sent to a central database where a plurality of such images can be stored and later retrieved. The images can be indexed by body region or other parameters such as time, date, location, etc. The mobile application can also be used to access the database and show the images which may be ordered by body region or the other parameters. The database may comprise a cloud-based database, for example. Communication between the database and the computing device and application of the user will generally be secure and HIPAA-compliant.

An aspect of the present disclosure provides a method for acquiring and for acquiring and cataloging an image of a subject. An image of a subject may be displayed. A map may be overlaid over the acquired image. The map may comprise a plurality of tapping areas corresponding to a plurality of body regions of the subject. The image may be captured in response to a user tapping a selected tapping area. The captured image may comprise a body region tag associated with the selected tapping area. The image may be tagged with body region and other information, such as time and location, simultaneously with the capture of the image.

The image of the subject may be displayed on a touch screen display. For example, the image may be displayed on a touch screen user interface. The image of the subject may be displayed by the display of a body-worn computer, a head-worn computer, a wrist-worn computer, a forearm-warn computer, an armband worn computer, a smartphone, a tablet computer, a laptop computer, a palmtop computer, a personal digital assistant, a personal computer, or a computing device. Any number of image processing tools may also be provided so that the image can be filtered, magnified, shrunken, distorted, color swapped, or otherwise altered before an image is captured. Such tools may be provided as buttons on the touch screen user interface. The touch screen user interface may also comprise an input box where the user can input notes. Capturing the image may include automatically tagging the captured image with the user generated notes.

The plurality of tapping areas may comprise a full body map. The plurality of tapping areas may comprise a full body map. The full body map may be semi-transparent. The plurality of tapping areas may comprise a toggle button. The overlaid map may be configured to switch from a front body view to a back body view or vice versa in response to a user touching the toggle button.

The plurality of tapping areas may comprise a zoom button. The overlaid map may be configured to be magnified or shrunk in response to a user touching the toggle button.

The image may be captured by providing one or more of an identity, time, date, or location tag to the captured image. The patient identity tag comprises one or more of a first name, a middle name, a last name, an age, a date of birth, a social security number, a government identification number, a medical record number, a gender, a height, a weight, a body mass index, an ethnicity, a nationality, or a medical history of the subject or user. In capturing the image, one or more of an ICD-9 code, an ICD-10 code, or a SNOMED code tag can be provided to the captured image. An image filter, a magnification factor, or color swap tag may also be provided.

The captured image may be sent to an accessible central database for indexing. A search field may be displayed. The search field may be configured for accessing the database. The central database may comprise a plurality of indexed images. The plurality of indexed images may be indexed by one or more of time, location, body region, clinic, hospital, and subject identity. Any of the procedures, methods, steps, and sub-steps described herein may be performed by a computer application. This computer application may be downloaded from the Internet or other network, for example, a wide area network. For example, the computer application may comprise a mobile software distribution network such as Palm/HP's App Catalog, Apple's App Store, BlackBerry's BlackBerry World, Google's Google Play, Mozilla Foundation's Firefox Marketplace, Nokia's Nokia Store, Samsung's Samsung Apps, Microsoft's Windows Phone Stores, Microsoft's Windows Store, Amazon.com's Amazon Appstore, LG's LG Application Store, and the like. This computer application may also be downloaded from a personal or other computer or computing device. The downloaded computer application may comprise a mobile application, for example.

The displayed image may be provided from one or more of body-worn computer camera, a head-worn computer camera, a wrist-worn computer camera, a forearm-warn computer camera, an armband worn computer camera, a smartphone camera, a tablet computer camera, a laptop computer camera, a palmtop computer camera, a personal digital assistant camera, a personal computer camera, a web cam, a video camera, a digital camera, an MRI scanner, a CT scanner, an x-ray camera, an infrared camera, or an ultrasound imaging device.

Another aspect of the present disclosure may provide a non-transitory computer readable medium of a computing device storing a set of instructions capable of being executed by the computing device to perform any of the procedures, methods, steps, and sub-steps described herein. The computing device may comprises one or more of a body-worn computer, a head-worn computer, a wrist-worn computer, a forearm-warn computer, an armband worn computer, a smartphone, a tablet computer, a laptop computer, a palmtop computer, a personal digital assistant, a personal computer, or a computing device.

Another aspect of the present disclosure may provide a photographic medical documentation system for acquiring and cataloging one or more images of one or more patients by a user. The photographic medical documentation system may comprise a mobile computing device. The mobile computing device comprises a housing, a touch screen interface, a memory storage element, and a processor. The processor may be operably coupled to the touch screen interface and the memory storage element. The imaging source may be configured to communicate image data to the processor. The database may be configured to store medical record data of one or more patients. The memory storage element may comprise programmed instructions for a photograph documentation application (hereinafter “PDA”). The processor may be configured to run the programmed instructions for the PDA.

The PDA may be configured to display a camera preview screen. The camera preview screen may comprise a preview of an image. The image may be of a patient and may be imminently capturable by the imaging source and a semitransparent overlay of a full body map. The full body map may be divided into a plurality of anatomical body regions. Upon a tapping of a location within the full body map by the user, the image that is imminently capturable by the imaging source may be captured and stored in the database as a photographic medical record. The captured image may be labeled and tagged with an anatomical location that corresponds to the location of the tapping within the full body map by the user. The captured image may be stored a medical record of the database that corresponds to the patient being imaged. The captured image may be labeled and tagged with a time and a date stamp. The captured image may be labeled and tagged with at least one of an ICD-9 code, an ICD-10 code, or a SNOMED code.

The camera preview screen may further comprise a front/back button configured to toggle the semitransparent overlay of the full body map between a front view and a back view. The PDA may be further configured to display a zoomed camera preview screen. The zoomed camera preview screen may comprise a preview of the image of the patient that is imminently capturable by the imaging source and a semitransparent overlay of a partial body map. The partial body map may show an anatomical region of interest. Upon a tapping of a location within the partial body map by the user, the image that is imminently capturable by the imaging source may be captured and stored in the database as a photographic medical record. The captured image may be labeled and tagged with an anatomical location that corresponds to the location of the tapping within the partial body map by the user. The captured image may be stored a medical record of the database that corresponds to the patient being imaged. The captured image may be labeled and tagged with a time and a date stamp. The captured image may be labeled and tagged with at least one of an ICD-9 code, an ICD-10 code, or a SNOMED code.

The PDA may be further configured to display a patient list view screen. The patient list view screen may comprise a list of the one or more patients of whom the database has records for a search field configured to allow the user to search for a given patient by his or her name. A new patient button configured to allow the user to enter a new patient into the database. The patient list view screen may further comprise a snap photo button configured to direct the PDA to display the camera preview screen and a preferences button configured to allow the user to alter settings for the PDA. Upon a tapping of a selected patient's name in the patient list view screen by the user, the PDA is further configured to display a patient ID screen that corresponds to the selected patient. The patient ID screen may be configured to display basic information about the selected patient. This basic information comprising at least a first and a last name of the patient. The patient ID screen may comprise a snap photo button configured to direct the PDA to display the camera preview screen and to direct the PDA to store any patient images captured by the imaging source in a record of the database that corresponds to the selected patient. The basic information about the selected patient may further comprise at least one of the following: a headshot of the selected patient, a date of birth of the selected patient, or a medical record number of the patient. The patient ID screen may comprise an image library button configured to direct the PDA to display an image library screen for the selected patient. The image library screen may be configured to display thumbnails of all photographic medical records for the selected patient that may be stored in the database. The PDA may be configured to display an enlarged image view of any selected photographic medical record for the selected patient upon the user tapping a corresponding thumbnail for the selected photographic medical record. The image library screen may be displayed by the PDA as an image library timeline view. The image library timeline view may comprise a chronologically ordered display of the thumbnails of the selected patient's photographic medical records. The image library screen may be displayed by the PDA as an image library by location view screen. The image library by the location view screen may display of a full body map. The full body map being divided into anatomical regions. Upon selection of an anatomical region by the user via tapping the selected anatomic region in the full body map, the PDA may display thumbnails of all the selected patients photographic medical records that are tagged with a location corresponding to the selected anatomical region.

The mobile computing device may comprise a smart phone, a tablet computer, any computing device mentioned herein, or the like.

The imaging source may comprise a camera. The camera, the processor, the touch screen interface, and the memory storage element may be integrated into the housing.

The database may be implemented with the memory storage element. The database may be remotely located and the mobile computing device may further comprise a means of data communication with the remotely located database. The means of data communication with the remotely located database may comprise a wireless internet connection or a connection to a cellular data network.

The imaging source may comprises one or more of the following, an MRI scanner, a CT scanner, an x-ray camera, an ultrasound imaging device, any imaging device mentioned herein, or the like. The imaging source has a means of data communication with the mobile computing device.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a mobile computing device of the present disclosure displaying a patient list view screen.

FIG. 2 shows a mobile computing device of the present disclosure displaying a patient ID screen.

FIG. 3 shows an embodiment of the camera preview screen.

FIG. 4 shows an embodiment of a zoomed camera preview screen.

FIG. 5 shows an embodiment of an image library with a timeline view.

FIG. 6 shows an embodiment of an image library with a “by location” view.

FIG. 7 shows an enlarged image view screen.

FIG. 8 shows a front view of a full body map for a female patient.

FIG. 9 shows a back view of a full body map for a female patient.

FIG. 10 shows a front view of a full body map for a male patient.

FIG. 11 shows a back view of a full body map for a male patient.

FIG. 12 shows a body map illustration of a zoomed frontal head view.

FIG. 13 shows a zoomed body map illustration of a back view of a head.

FIG. 14 shows a body map illustration of a front view of a right hand.

FIG. 15 shows a body map illustration of a back view of a right hand.

FIG. 16 shows a body map illustration of a front view of a left hand.

FIG. 17 shows a body map illustration of a back view of a left hand.

FIG. 18 shows a body map illustration of a right foot.

FIG. 19 shows a body map illustration of a left foot.

### DETAILED DESCRIPTION OF THE INVENTION

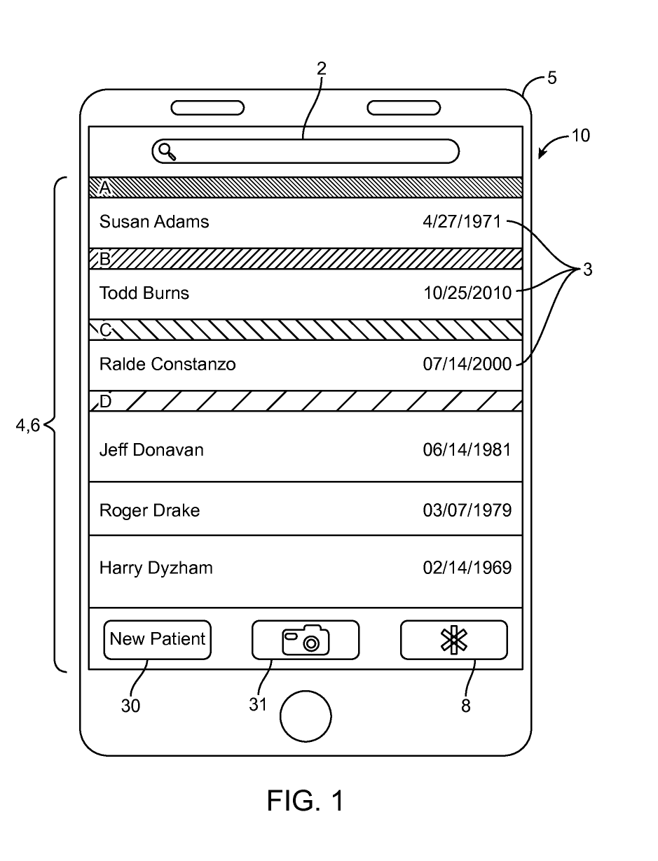

Referring now to FIGS. 1-7, exemplary embodiments of the disclosure may be directed toward systems and methods for acquiring and cataloging photographic medical records. Such systems and methods may comprise a mobile computing device 10. Such mobile computing devices typically comprise a housing 5, a touch screen interface 6, an imaging source (such as a camera), a memory storage element (not shown), and a processor (not shown). The mobile computing device may typically be a camera equipped smart phone or tablet computer such as the Apple iPhone or Apple iPad; such devices generally have all the above mentioned elements integrated therewithin. Such systems and methods may also comprise a database configured to store medical record data of one or more patients, including photographic medical records. The database may be implemented in the local memory of the mobile computing device or implemented remotely with a means of data communication with the mobile computing device. In such embodiments, the mobile computing device may communicate with the database via internet connections, cellular data networks, and the like.

In some embodiments, the imaging source may comprise an independent piece of medical imaging equipment that may be in communication with a mobile computing device. Such an example may comprise a CT scanner paired to an iPhone via a wireless Bluetooth connection. Embodiments of the mobile computing device are typically configured to run a PDA. The PDA may serve as a user interface for the mobile computing device which helps the user navigate the database.

Referring now to FIG. 1, the user (typically a medical practitioner) may typically log in to the PDA in order to gain access to the database. The PDA may gather patient information from the database and display the patient's names 4 in a patient list view screen. The top of the patient list view screen may have search field 2, which when selected may produce a virtual key board allowing the user to search for a patient by name. The patient's names are typically displayed in alphabetical order with their corresponding dates of birth 3. The user may scroll through the displayed list with swiping finger motions on the touch screen interface 6. The patient list view screen may also have a new patient button, that when tapped will allow the user to enter information for a new patient and to update the database with that new patient. The patient list view screen may also have a snap photo button which will bring up the camera preview screen, and allow the user to capture medical images without having a patient profile in the database. Captured images are often assigned to auto populated patient profile which may be updated and corrected at a later time. The patient list view screen may also have a preferences button 8 which when tapped will allow the user to change the PDA preference settings. The user may select a patient by tapping their name on the touch screen interface. In response to patient selection, the PDA may display a patient ID screen for the selected patient.

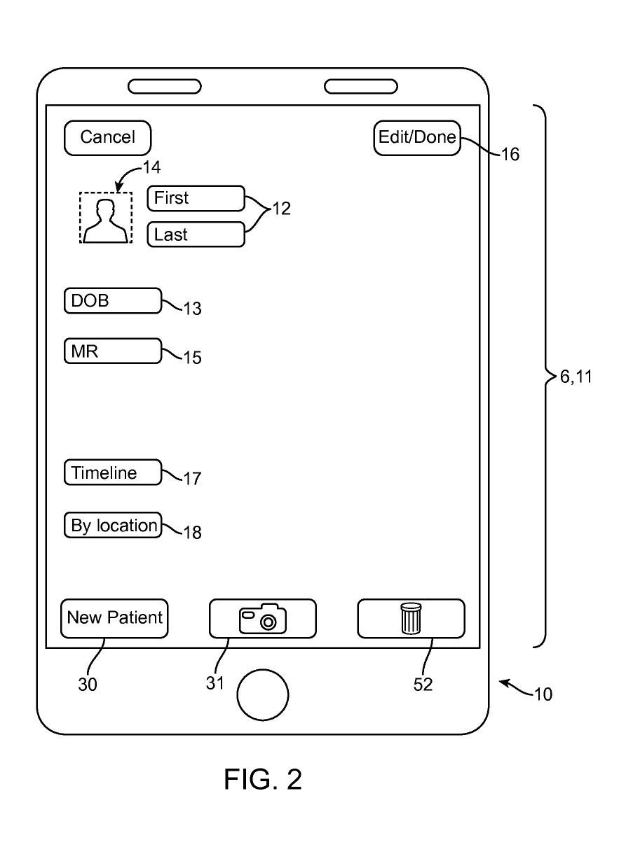

An exemplary patient ID screen is shown in FIG. 2. In exemplary embodiments, the patient ID screen 11 may show the selected patient's basic information such as name 12 and date of birth 13. The patient ID screen may also display a patient's photo 14 and medical record number 15. The PDA is typically configured to allow the user to edit the patient's basic information from the patient ID screen through an edit button 16, which makes the data fields of the patient ID screen editable.

Like the patient list view screen, the patient ID Screen may also have a new patient button 30. The patient ID screen may also have a snapshot button 31 and a trash button 32. The snapshot button will typically bring up the camera preview screen, and images subsequently captured may be uploaded to the database as records for the selected patient. The trash button 32 can be configured to delete the selected patient's profile.

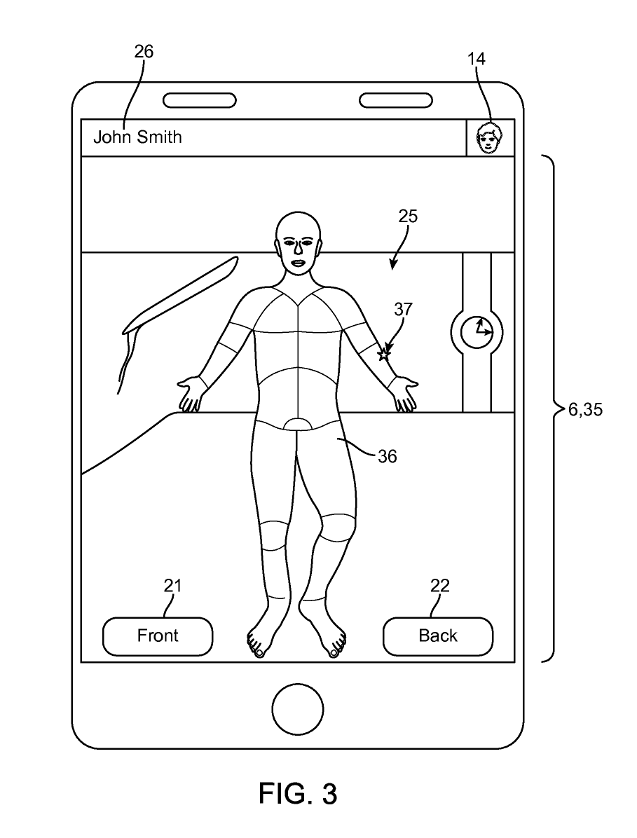

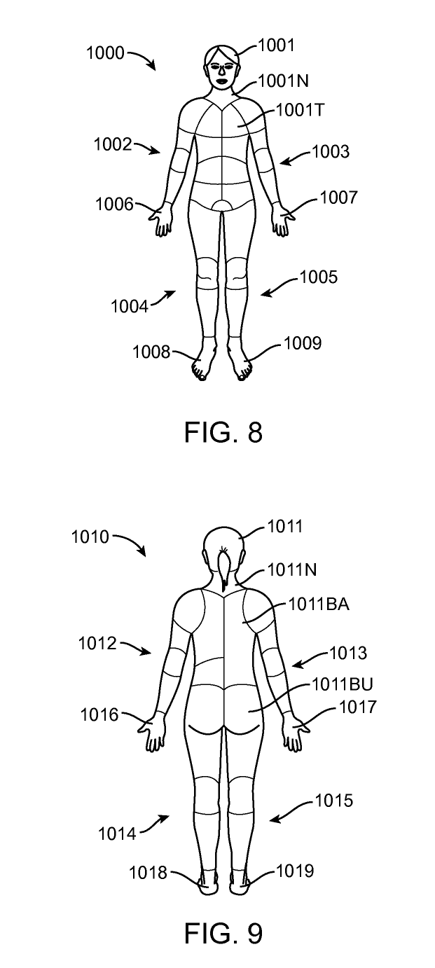

In exemplary embodiments, the PDA may present a camera preview screen which may be configured to aid the user in acquiring and cataloging medical images of the patient. An exemplary camera preview screen 35 is shown in FIG. 3. The camera preview screen 35 may comprises a semitransparent full body map 36 showing different anatomical regions of the patient's body. This map can be overlayed upon a preview of the image 25 that the imaging source is ready to capture. Typically, the mobile computing device will have an integrated camera and this preview is the image that the camera is currently viewing and ready to capture. The user may then tap a location 37 on the full body map corresponding to the location on the patient of where the image is to be taken. The mobile computing device's imaging source may then capture the image and store the image as a medical record for the patient in the database. The PDA may then also tag the image with the anatomical location indicated by the user's tap and time/date stamp. The camera preview screen may have front and back buttons 21 and 22 to toggle between front and back views for the full body map. Typically, the camera preview screen will show the patient's name 26 at the top of the screen, which when tapped will take the user back to the patient ID screen 11. Additionally, in some embodiments the patient's head shot is shown. If the headshot region is tapped then the preview image is captured and the user is prompted if the captured image should be used to replace the headshot. Example front and back full body maps for males and females are shown in FIGS. 8-11.

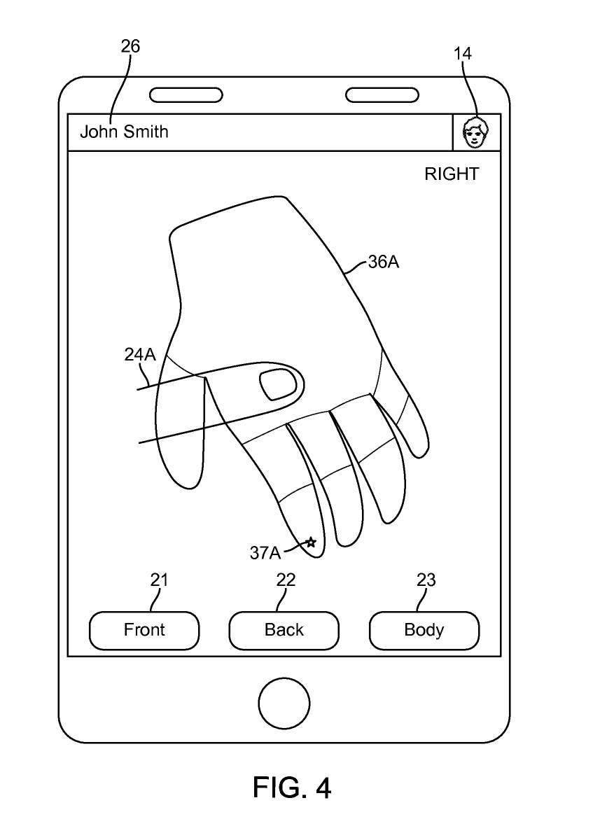

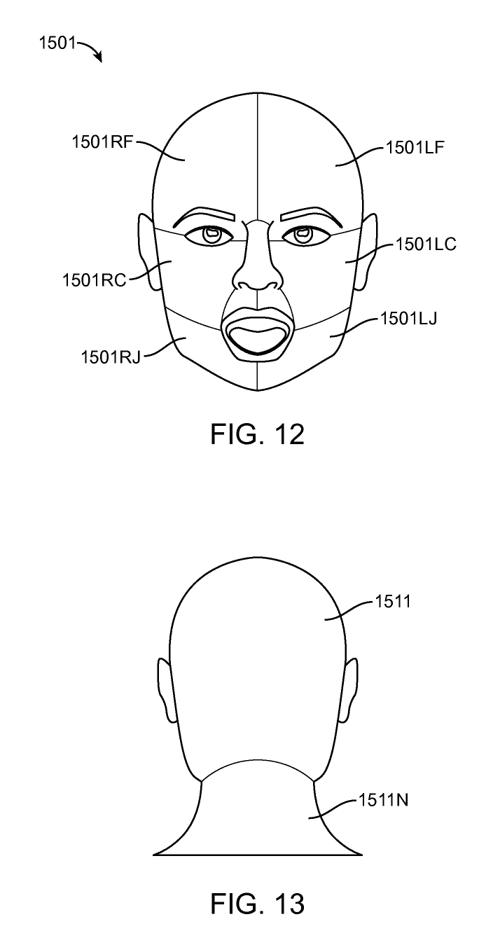

For some anatomical regions, such as the feet and face, a greater amount of precision may be desired when tagging the anatomical location. When tapping these anatomical regions in the full body map in the camera preview screen, the PDA will present a zoomed camera preview screen. A zoomed camera preview screen is shown in FIG. 4. The zoomed camera preview screen shows a preview 24A of an image which may be imminently captured and an overlay of the selected anatomical region instead of the whole body 36A. Tapping within the overlay of the selected anatomical region may result in the image being captured. The captured image may then be time stamped and tagged with the tapped location 37A within the zoomed anatomical region. A button is typically present to revert back to the non-zoomed camera preview screen. The anatomical regions that trigger a zoomed preview view screen may be selected and changed via the preferences button (see FIG. 1). Example maps (overlays) for zoomed in anatomical regions are shown in FIGS. 12-19.

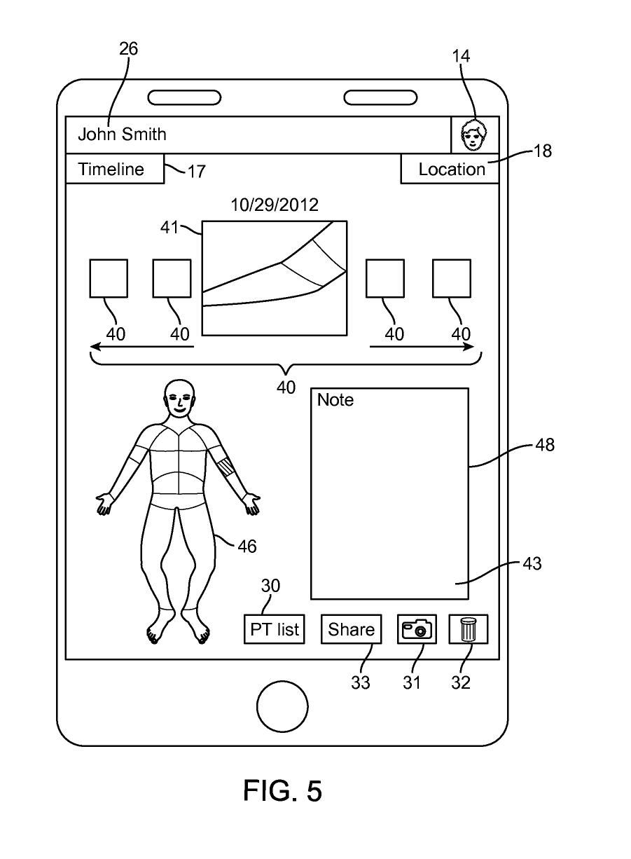

In exemplary embodiments, a timeline button 17 and a “by location” button 18 on the patient ID screen is configured to trigger an image library timeline view or an image library by location view. Either of these image library views allows the user to view all photographic medical records contained in the database for the selected patient. The image library timeline view (see FIG. 5) displays all photographic medical records for the selected patient in chronologically arranged thumbnails 40. Typically, the thumbnails are arranged from left to right with newer images to the right and the current image 41 is shown in the center with the date and time stamp above the image. The user may scroll through the thumbnails by swiping the touch screen interface with his or her finger. Tapping on a thumbnail will enlarge the image to produce an enlarged image view screen (see below). The image library time line screen may also feature a body map which highlights the anatomical region of the image currently being viewed. There may also be a text box 48 for the user to create notes.

The image library timeline screen may also feature one or more of the following buttons: (1) a “pt list” button 30 which will take the user back to the patient list, (2) a “share” button 33 which is configured to allow the user to select and share data and images from the image library timeline screen via e-mail, SMS, text messaging, or the like, (3) a “snap photo” button 31 which will take the user to the camera preview screen for another photo of the patient, and (4) A “trash” button 32 which will prompt the user to delete the current image.

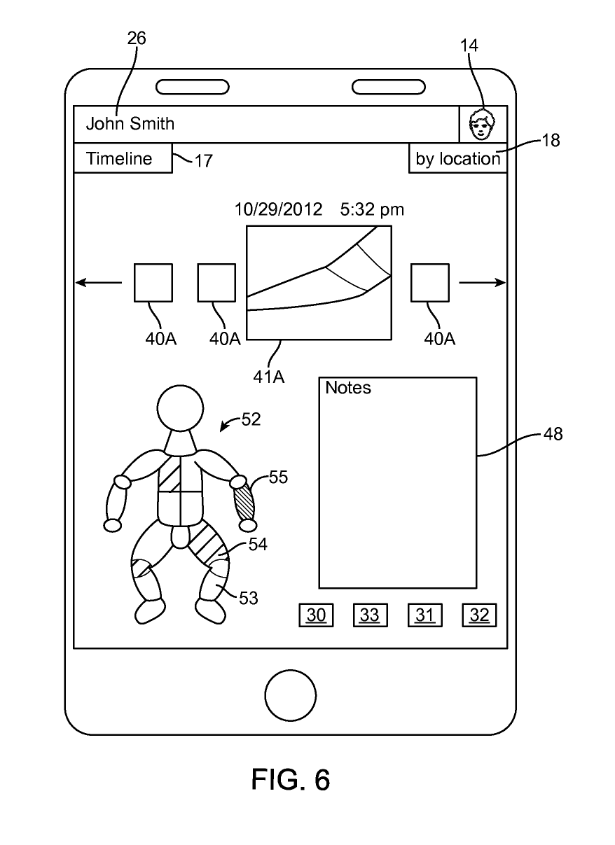

The image library by location view 50 shows chronologically arranged thumbnails 40A of the patient's photographic medical records in the same fashion as the image library timeline screen (with the selected image 41A in the center). However, the image library by location view only shows images from a designated anatomical region 55 (See FIG. 6). The designated anatomical region may be selected by tapping the region on a full body map 52. Regions with no photographic records show up as clear 53 while regions with photographic records will show up as shaded 54. The currently viewed region (designated anatomical region) 55 will show up as bolded on the map. The image library by location view may also feature one or more of the following buttons: (1) a “pt list” button which will take the user back to the patient list, (2) a “share” button which is configured to allow the user to select and share data and images from the image library by location view via email, SMS, or other means, (3) a “snap photo” button which will take the user to the camera preview screen for another photo of the patient, and (4) a “trash” button which will prompt the user to delete the current image.

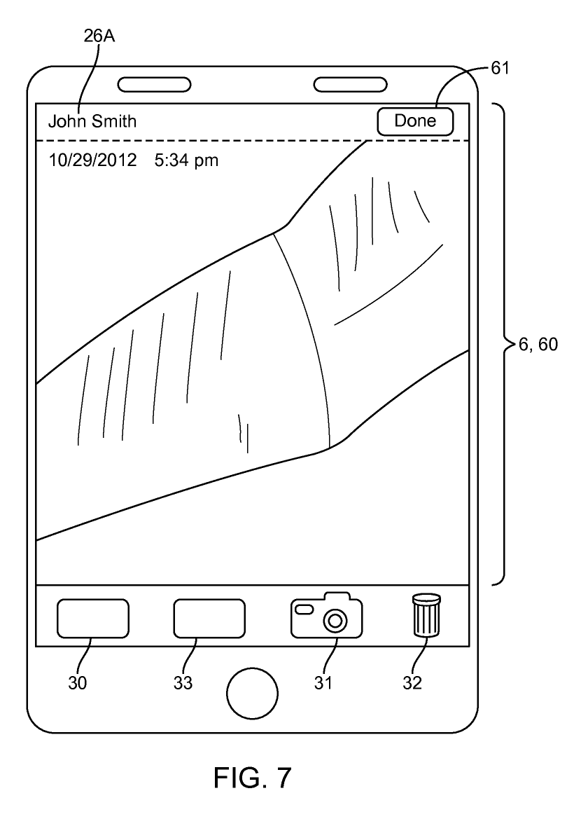

As mentioned above, the currently viewed thumbnail/photo graph in either the image library timeline view or the image library by location view may be viewed in an enlarged image view. (See. FIG. 7.) This screen will show the selected image 60 maximally filling the screen 6. Swiping from left to right will show the next image, while swiping from right to left will show older images. Tapping the screen may toggle the appearance and disappearance of buttons and information. On the top, the patient ID 26A (name/photo date & time stamp) will toggle along with a “done” button 61. The “done” button will return the user to the thumbnail view mode from which he or she came. On the bottom of the screen, the “patient list” (“pt list”), “share”, “snap photo”, and “trash” buttons will toggle. In the center of the image the body map will appear and disappear to demonstrate the location of the image. These buttons have the same functions as described above.

In additional aspects of the present disclosure, a mobile computing device may be configured to receive images from the patient, sent via phone or email. The user or the patient may identify the anatomical location of the image via a body map. The user provided image may then be stores in the database as a photographic medical record.

Additionally, the PDA may take steps to merge and or synchronize the database with electronic medical records from various outpatient or inpatient care teams.

The body map overlay may be selected from a variety of body maps.

A front full body map 1000 for a female patient or subject can be selected as shown in FIG. 8. The full body map 1000 may comprise a head region 1001, a neck region 1001N, a torso region 1001T, a right arm region 1002, a left arm region 1003, a right leg region 1004, a left leg region 1005, a right foot region 1008, and a left foot region 1009.

A back full body map 1010 for a female patient or subject can be selected as shown in FIG. 9. The full body map 1010 may comprise a head region 1011, a neck region 1011N, a back region 1011BA, a buttock region 1011BU, a left arm region 1012, a right arm region 1013, a left leg region 1014, a right leg region 1015, a left hand region 1016, a right hand region 1017, a left leg region 1018, and a right leg region 1019.

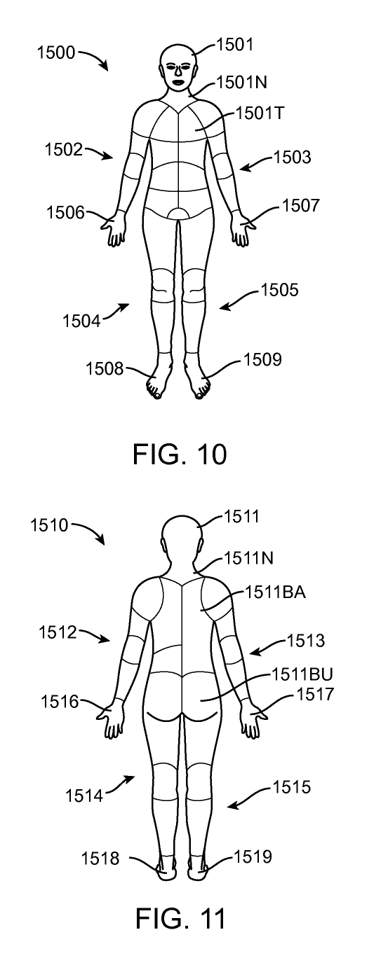

A front full body map 1500 for a male patient or subject can be selected as shown in FIG. 10. The full body map 1500 may comprise a head region 1501, a neck region 1501N, a torso region 1501T, a right arm region 1502, a left arm region 1503, a right leg region 1504, a left leg region 1505, a right hand region 1506, a left hand region 1507, a right foot region 1508, a left foot region 1509.

A back full body map 1510 for a male patient or subject can be selected as shown in FIG. 11. The full body map 1510 may comprise a head region 1511, a neck region 1511N, a back region 1511BA, a buttock region 1511BU, a left arm region 1512, a right arm region 1513, a left leg region 1514, a right leg region 1515, a left hand region 1516, a right hand region 1517, a left foot region 1518, and a right foot region 1519.

A face map 1501 for a subject or patient, that is, a body map illustration of a zoomed frontal head view, can be selected as shown in FIG. 12. The face map 1501 may comprise a right forehead region 1501RF, a left forehead region 1501LF, a right cheek region 1501RC, a left cheek region 1501LC, a right jaw region 1501RJ, and a left jaw region 150111. Additional regions may include one or more ears, one or more eyes, a nose, an upper lip, a lower lip, upper teeth, lower teeth, a tongue, and the throat.

A body map of the back of the head can be selected as shown in FIG. 13 which shows a zoomed body map illustration of a back view of a head comprising the head region 1511 and the neck region 1511N.

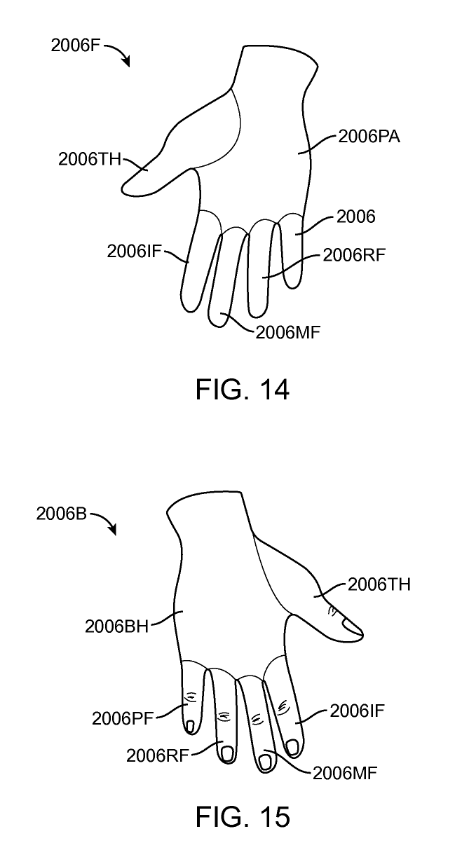

A body map of the open palm 2006F can be selected as shown in FIG. 14 which shows a body map illustration of a front view of a right hand comprising an open palm region 2006PA, a thumb region 2006TH, an index finger region 20061F, a middle finger region 2006MF, a ring finger region 2006RF, and a pinky finger region 2006PF.

A body map of the back of the hand can be selected as shown in FIG. 15 which shows a body map illustration of a back view of a right hand comprising the back of the hand region 2006BH, the thumb region 2006TH, the index finger region 2006IF, the middle finger region 2006MF, the ring finger region 2006RF, and the pink finger region 2006PF.

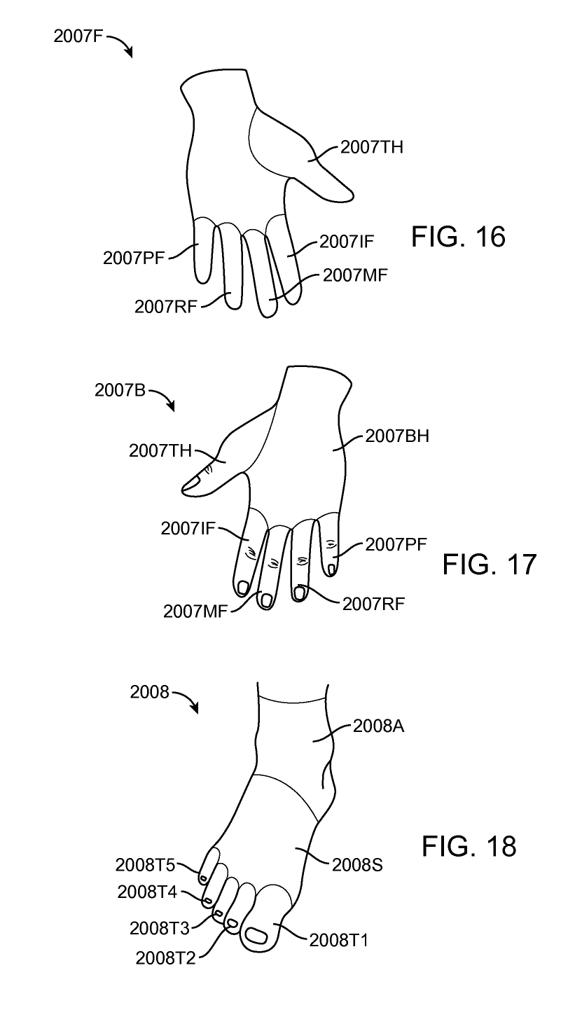

FIG. 16 shows a body map illustration of a front view 2007F of a left hand. The front view region 2007F comprises a thumb region 2007TH, an index finger region 2007IF, a middle finger region 2007MF, a ring finger region 2007RF, and a pinky finger region 2007PF.

FIG. 17 shows a body map illustration of a back view 2007B of a left hand. The back view 2007B comprises the thumb region 2007TH, the index finger region 2007IF, the middle finger region 2007MF, the ring finger region 2007RF, and the pinky finger region 2007PF.

FIG. 18 shows a body map illustration 2008 of a right foot comprising an ankle region 2008A, a sole region 2008S, a big toe region 2008T1, a second toe region 2008T2, a third toe region 2008T3, a fourth toe region 2008T4, and a pinky toe region 2008T5.

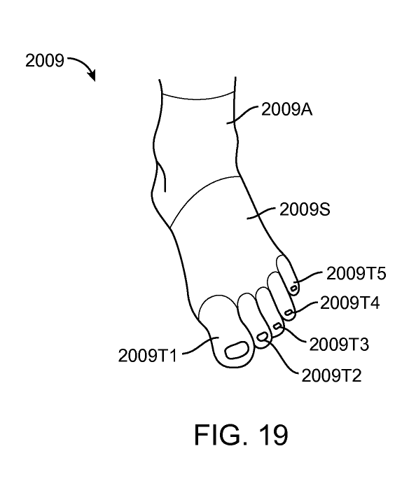

FIG. 19 shows a body map illustration 2009 of a left foot comprising an ankle region 2009A, a sole region 2009S, a big toe region 2009T1, a second toe region 2009T2, a third toe region 2009T3, a fourth toe region 2009T4, and a pinky toe region 2009T5.

Each of above regions may be tapped to capture an image and tag the captured image with the corresponding body part. Each of these regions may comprise a plurality of sub-regions which may be tapped to capture an image and tag the captured image with the corresponding body part.

It is further noted that the systems and methods may be implemented on various types of computer architectures, such as for example on a networked system or in a client-server configuration, or in an application service provider configuration, on a single general purpose computer or workstation. The systems and methods may include data signals conveyed via networks (for example, local area network, wide area network, internet, combinations thereof), fiber optic medium, carrier waves, wireless networks. for communication with one or more data processing devices. The data signals can carry any or all of the data disclosed herein (for example, user input data, the results of the analysis to a user) that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein.

The systems' and methods' data (for example, associations, mappings) may be stored and implemented in one or more different types of computer-implemented ways, such as different types of storage devices and programming constructs (for example, data stores, RAM, ROM, Flash memory, flat files, databases, programming data structures, programming variables, IF-THEN (or similar type) statement constructs). It is noted that data structures describe formats for use in organizing and storing data in databases, programs, memory, or other computer-readable media for use by a computer program.

The systems and methods may be provided on many different types of computer-readable media including computer storage mechanisms (for example, CD-ROM, diskette, RAM, flash memory, computer's hard drive, magnetic tape, and holographic storage) that contain instructions (for example, software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that the meaning of the term module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

In general, in yet another aspect, a computer readable medium is provided including computer readable instructions, wherein the computer readable instructions instruct a processor to execute step a) of the methods described above. The instructions can operate in a software runtime environment.

In general, in yet another aspect, a data signal is provided that can be transmitted using a network, wherein the data signal includes said posterior probability calculated in step a) of the methods described above. The data signal can further include packetized data that is transmitted through wired or wireless networks.

In an aspect, a computer readable medium comprises computer readable instructions, wherein the instructions when executed carry out a calculation of the probability of a medical condition in a patient based upon data obtained from the patient corresponding to at least one biomarker. The computer readable instructions can operate in a software runtime environment of the processor. In an embodiment, a software runtime environment provides commonly used functions and facilities required by the software package. Examples of a software runtime environment include, but are not limited to, computer operating systems, virtual machines or distributed operating systems. As will be appreciated by those of ordinary skill in the art, several other examples of runtime environment exist. The computer readable instructions can be packaged and marketed as a software product or part of a software package. For example, the instructions can be packaged with an assay kit for PSA.

The computer readable medium may be a storage unit of the present invention as described herein. It is appreciated by those skilled in the art that computer readable medium can also be any available media that can be accessed by a server, a processor, or a computer. The computer readable medium can be incorporated as part of the computer-based system of the present disclosure, and can be employed for a computer-based assessment of a medical condition.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The methods of the invention may be packaged as a computer program product, such as the expression of an organized set of instructions in the form of natural or programming language statements that is contained on a physical media of any nature (for example, written, electronic, magnetic, optical or otherwise) and that may be used with a computer or other automated data processing system of any nature (but preferably based on digital technology). Such programming language statements, when executed by a computer or data processing system, cause the computer system to act in accordance with the particular content of the statements. Computer program products include without limitation: programs in source and object code and/or test or data libraries embedded in a computer readable medium. Furthermore, the computer program product that enables a computer system or data processing equipment device to act in preselected ways may be provided in a number of forms, including, but not limited to, original source code, assembly code, object code, machine language, encrypted or compressed versions of the foregoing and any and all equivalents.

Information before, after, or during processing can be displayed on any graphical display interface in communication with a computer system (for example, a server). A computer system may be physically separate from the instrument used to obtain values from the subject. In an embodiment, a graphical user interface also may be remote from the computer system, for example, part of a wireless device in communication with the network. In another embodiment, the computer and the instrument are the same device.

An output device or input device of a computer system of the invention can include one or more user devices comprising a graphical user interface comprising interface elements such as buttons, pull down menus, scroll bars, fields for entering text, and the like as are routinely found in graphical user interfaces known in the art. Requests entered on a user interface are transmitted to an application program in the system (such as a Web application). In one embodiment, a user of user device in the system is able to directly access data using an HTML interface provided by Web browsers and Web server of the system.

A graphical user interface may be generated by a graphical user interface code as part of the operating system or server and can be used to input data and/or to display input data. The result of processed data can be displayed in the interface or a different interface, printed on a printer in communication with the system, saved in a memory device, and/or transmitted over a network. A user interface can refer to graphical, textual, or auditory information presented to a user and may also refer to the control sequences used for controlling a program or device, such as keystrokes, movements, or selections. In another example, a user interface may be a touch screen, monitor, keyboard, mouse, or any other item that allows a user to interact with a system of the invention as would be obvious to one skilled in the art.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for acquiring and for acquiring and cataloging an image of a subject, the method comprising:
displaying an image of a subject;
overlaying a map over the acquired image, wherein the map comprises a plurality of tapping areas corresponding to a plurality of body regions of the subject; and
capturing the image in response to a user tapping a selected tapping area, wherein the captured image comprises a body region tag associated with the selected tapping area.

2. The method of claim 1, wherein the image of the subject is displayed on a touch screen display.

3. The method of claim 1, wherein the image of the subject is displayed by the display of a body-worn computer, a head-worn computer, a wrist-worn computer, a forearm-warn computer, an armband worn computer, a smartphone, a tablet computer, a laptop computer, a palmtop computer, a personal digital assistant, a personal computer, or a computing device.

4. The method of claim 1, wherein the plurality of tapping areas comprises a full body map, an arm map, a leg map, a head map, a face map, a torso map, a back map, a hand map, a foot map, or a face map.

5. The method of claim 1, wherein the plurality of tapping areas is semi-transparent.

6. The method of claim 1, wherein the plurality of tapping areas comprises a toggle button, wherein overlayed map is configured to switch from a front body view to a back body view or vice versa in response to a user touching the toggle button.

7. The method of claim 1, wherein the plurality of tapping areas comprises a zoom button, wherein the overlayed map is configured to be magnified or shrunk in response to a user touching the toggle button.

8. The method of claim 1, wherein capturing the image comprises providing one or more of an identity, time, date, or location tag to the captured image.

9. The method of claim 8, wherein the patient identity tag comprises one or more of a first name, a middle name, a last name, an age, a date of birth, a social security number, a government identification number, a medical record number, a gender, a height, a weight, a body mass index, an ethnicity, a nationality, or a medical history of the subject or user.

10. The method of claim 1, wherein capturing the image further comprises providing one or more of an ICD-9 code, an ICD-10 code, or a SNOMED code tag to the captured image.

11. The method of claim 1, wherein capturing the image further comprises providing an image filter, a magnification factor, or color swap tag.

12. The method of claim 1, further comprising sending the captured image to a central database for indexing.

13. The method of claim 12, further comprising displaying a search field configured for accessing the database.

14. The method of claim 1, further comprising accessing a central database comprising a plurality of indexed images.

15. The method of claim 1, wherein the plurality of indexed images is indexed by one or more of time, location, body region, clinic, hospital, and subject identity.

16. The method of claim 1, further comprising downloading a computer application from the Internet, the downloaded computer application being configured for acquiring and cataloging an image of a subject.

17. The method of claim 16, wherein the downloaded computer application comprises a mobile application.

18. The method of claim 1, wherein the displayed image is provided from one or more of body-worn computer camera, a head-worn computer camera, a wrist-worn computer camera, a forearm-warn computer camera, an armband worn computer camera, a smartphone camera, a tablet computer camera, a laptop computer camera, a palmtop computer camera, a personal digital assistant camera, a personal computer camera, a web cam, a video camera, a digital camera, an MRI scanner, a CT scanner, an x-ray camera, an infrared camera, or an ultrasound imaging device.

19. A non-transitory computer readable medium of a computing device storing a set of instructions capable of being executed by the computing device to perform the method of claim 1.

20. The non-transitory computer readable medium of claim 19, wherein the computing device comprises one or more of a body-worn computer, a head-worn computer, a wrist-worn computer, a forearm-warn computer, an armband worn computer, a smartphone, a tablet computer, a laptop computer, a palmtop computer, a personal digital assistant, a personal computer, or a computing device.
